(19) United States
(12) Patent Application Publication
(10) Pub. No.: US 2022/0208160 A1
(43) Pub. Date: Jun. 30, 2022

(54) Integrated Musical Instrument Systems

(71) Applicant: Jorge Marticorena, Woodside, NY (US)

(72) Inventor: Jorge Marticorena, Woodside, NY (US)

(21) Appl. No.: 17/681,779

(22) Filed: Feb. 27, 2022

Related U.S. Application Data
(63) Continuation-in-part of application No. 16/517,603, filed on Jul. 21, 2019, now abandoned.

(51) Int. Cl. G10H 1/00; G10H 1/46

(52) U.S. Cl. CPC G10H 1/0066; G10H 1/0008; G10H 1/46; G10H 2240/285; G10H 2210/325; G10H 2220/201; G10H 2240/311; G10H 2220/005; G10H 2220/265

(57) ABSTRACT

A system suitable for use as a musical instrument system is provided. The system includes at least one sensor. The system also includes at least one control surface configured to interface with the at least one sensor. Further, the system includes at least one controller configured to interface with the at least one sensor. Additionally, the system includes at least one program module configured to interface with the at least one sensor. The system includes an enclosure. The at least one sensor and the at least one control surface are positionable on the base. The system also includes at least one data processor configured to interface with the at least one sensor, the at least one control surface, and the at least one program module arranged to function as a musical instrument system. The system also includes an enclosure

### CROSS-REFERENCE TO RELATED APPLICATIONS

This application claims priority to provisional application 62/701,789 filed on Jul. 22, 2018, and is incorporated herein by reference in its entirety. Further, this application claims priority to non-provisional patent application Ser. No. 16/517,603 filed on Jul. 21, 2019, and is incorporated herein by reference in its entirety.

### REFERENCE TO APPLICATION SOURCE CODE, RULES, AND COMPONENTS IN APPENDIX

The material included in Appendix A through I are incorporated herein by reference in its entirety.

### FIELD OF THE INVENTION

The present invention relates generally to musical instruments, and more particularly, to integrated musical instrument systems, which utilize sensors to communicate with other digital audio technologies to produce integrated musical sound.

### BACKGROUND OF THE INVENTION

Many methods and systems have been used unsuccessfully attempting to incorporate unique musical sounds generated by a musician produced solely by movement of a musician or an object controlled by a musician. Several devices and methods have been created attempting unsuccessfully to solve the problem of producing integrated musical sounds without physical contact in a practical way. These previous systems and methods have not been effective in solving the problem of overcoming the limitations of a musician's interaction to produce integrated musical sounds solely by physical touch. Further, these previous systems and methods have not been effective in taking advantage of digital audio technology to augment interaction between a musician and an instrument and/or digital audio software beyond the limitations of physical touch to control and/or produce integrated musical sounds.

There have been many unsuccessful attempts by musicians to digitally generate musical sounds other than by pushing buttons, pressing keys, striking pads, or turning dials. For musicians, playing live music is about moving the body and being physical. Current musical instruments and device hardware continue to limit the ways in which a musician can use digital controls to bridge the gap between their physical movements and sounds that those movements can generate and/or manipulate, alone or concurrently, with other analog or digital instruments.

Accordingly, there is an established need for integrated musical instrument systems which solve at least one of the aforementioned problems. Further, there is an established need for integrated musical instrument systems which can combine various sounds generated by movement without the necessity of physical touch.

### SUMMARY OF THE INVENTION

The present invention is directed to innovative integrated musical instrument systems. These systems are used to produce integrated musical sounds that are controlled by a musician's hands, head, feet, hands, fingers, torso, appendages, and/or objects as the musician physically interacts with devices. These systems incorporate the musical sounds resulting from movement and/or presence of physical objects in the proximity of the devices. These devices provide unique methods of playing sounds which can be programmed and varied, and wherein sound can be manifested and controlled directly in real-time from digital and/or analog audio software and/or hardware, or concurrently with sounds generated by a musical instrument the musician is playing by reacting to the physical movements manifested while in the act of playing. These devices can also directly manipulate the sound generated by a musical instrument the musician is playing.

The devices can include, but are not limited to, proximity sensors, motion sensors, range sensors, sonic sensors, laser sensors, accelerometers, magnetometers, and/or gyroscope sensors. In an embodiment of the present invention, the integrated musical instrument systems can include a controller. The controller can include multiple proximity sensors configured to transmit data to a plurality of computer interfaces and can affect parameters within those interfaces in a binary (on/off) fashion and/or in gradual increments via bodily motion, for example, waving a hand over the sensors without any physical contact.

According to an aspect of the present invention, a system suitable for use as a musical instrument system is provided. The system includes at least one sensor. The system also includes at least one control surface configured to interface with the at least one sensor. Further, the system includes at least one controller configured to interface with the at least one sensor. Additionally, the system includes at least one program module configured to interface with the at least one sensor. The system includes a base. The at least one sensor and the at least one control surface are positionable on the base. The system also includes at least one data processor configured to interface with the at least one sensor, the at least one control surface, and the at least one program module arranged to function as a musical instrument system. The system also includes that the at least one sensor is configured to transmit data in a binary and gradual fashion simultaneously when triggered by an object placement, object motion, and object velocity, wherein the data transmitted by the at least one sensor gradually changes as a distance between the object and the at least one sensor changes while the data gets concurrently processed to play and manipulate sounds, effects and/or parameters in accordance with the object placement and the object motion and the object velocity.

Further, the system also includes a portable device configured for controller functionality, wherein the portable device is housed by an enclosure; and where the dimensions of the enclosure are about 5½ inches long by about 1½ inches wide by about ⅜ inches of height. The system can also include a top display positioned centrally on a top surface of the enclosure, wherein a surface area of the display occupies from about ⅛ to about ⅓ of a total surface area of the top surface. The system also includes an USB port positioned on a side of the enclosure configured to connect to a computer. The system can also include two proximity sensors positionable on a top surface of the enclosure, wherein one sensor is located on a left-hand side and another sensor on a right hand side of the top surface of the enclosure and spaced away from a top display and from each other and arranged such that the proximity sensors can be controlled and/or actuated independently from one another and configured so a musician can utilize left and right hands to interact with the left and right hand top sensors without disrupting visibility of the top display. Additionally, the system can also include 2 push buttons to navigate banks positioned on a back side surface of the enclosure and designed to be operated by the musician's thumb. Further still, the system can include a rotary thumbwheel positioned on the back side surface of the enclosure and structured to be operated by the musician's thumb.

According to another aspect of the present invention, an apparatus suitable for use as a musical instrument device is provided. The apparatus includes at least one sensor. The apparatus also includes at least one control surface configured to interface with the at least one sensor. Further, the apparatus includes at least one controller configured to interface with the at least one sensor. Additionally, the apparatus includes at least one program module configured to interface with the at least one sensor. The apparatus includes a base. The at least one sensor and the at least one control surface are positionable on the base. The apparatus also includes at least one data processor configured to interface with the at least one sensor, the at least one control surface, and the at least one program module arranged to function as a musical instrument apparatus.

According to yet another aspect of the present invention, a method of creating sound with an integrated musical instrument system is provided. The method includes initializing at least one sensor. The method also includes interfacing at least one control surface with the at least one sensor. Further, the method also includes coupling at least one controller with the at least one sensor. Additionally, the method includes programming at least one program module configured to interface with the at least one sensor. The method includes communicating with the at least one sensor, the at least one control surface, the at least one controller, and/or the at least one program module with at least one data processor. The method also includes actuating the integrated musical instrument system with motion to trigger and/or manipulate sounds and effects

In an embodiment of the present invention, the system can include a program module. The program module can be configured for a plurality of functions and/or responses including assigning multiple functions and/or responses to a single sensor that would otherwise need to be assigned to a greater number of physical controls.

In an aspect of the present invention, the integrated musical instrument systems can include a controller. The controller can include multiple proximity sensors configured to transmit Musical Instrument Digital Interface (MIDI) data to a digital audio workstation (DAW) and/or any digital MIDI-enabled device, such as, a synthesizer to trigger sounds and affect parameters within a software/device in both a binary (on/off) fashion or in a gradual fashion that increases and decreases in accordance with bodily motion, for example, by waving a hand over the sensors without any physical contact.

In another aspect of the present invention, the integrated musical instrument systems can be integrated into a plurality of digital and/or analog musical instruments in a plurality of physical arrangements. The system can be configured for personal preference directed by the musician's playing style and needs.

In yet another embodiment of the present invention, the integrated musical instrument system can also be incorporated in and/or onto and/or within a body, neck, and/or headstock of a guitar.

In another aspect, the integrated musical instrument system can be included in a modified body, neck, and/or headstock of the guitar.

In yet another aspect of the present invention, the integrated musical instrument systems can also include controllers, such as but not limited to, musical instrument digital interfaces (MIDI). The controllers may be incorporated into a musical instrument, or may be played on their own. The controllers can include a plurality of sensors. The sensors can be, but not limited to, proximity sensors. These proximity sensors can transmit MIDI data when a musician places an object, such as but not limited to, fingers, hands, arms, head, torso, body part, an/or objects controlled by the musician in proximity to the sensors. These sensors can be programmed to produce different sounds when, for example, waving a hand past a sensor and/or moving the hand up and down over the sensor. Frequency of movement, distance to the sensor, horizontal movement across the sensor, vertical movement over the sensor, and/or horizontal movement in other horizontal directions can also produce different sounds and/or change the parameters of the sounds being produced.

In another aspect of the present invention, the system can include a plurality of digital and/or analog musical instruments with a plurality of sensors incorporated within the instruments.

In another aspect, the system can trigger and/or manipulate programmed sounds mapped from a digital audio workstation (DAW) to the sensors through transmission of MIDI data.

In yet another aspect, the system can also include a plurality of sensors incorporated within a musical instrument.

In another aspect, the system can include a portable device that acts solely as a controller, a remote controller, or a MIDI controller. The portable device can include sensors. The sensors can be configured to generate sound by transmitting data, such as MIDI data, to a DAW and/or one or a plurality of MIDI-enabled devices when a musician places and/or moves an object in proximity to the sensors.

In yet another aspect, the system can also include proximity sensors incorporated into a body, neck, and/or headstock of a guitar in a or a plurality of physical arrangements.

In another aspect, the system can include external sounds and parameters mapped in a DAW directly to the sensors, in the same manner that one would map sounds and parameters in a DAW to buttons, keys, dials, knobs, sliders, and/or touch pads on other control surfaces, such as that of traditional MIDI controller. Moreover, each sensor has the distinct advantage of functioning like a button, key, dial, knob, slider, touch pad, all of the above or any combination of the aforementioned physical controls, without the limitations of the physical constitution and/or design that determines the functionality of those physical controls, to provide a more versatile, expressive, frictionless, and customizable method of controlling sounds and effects.

In yet another aspect, the system can also include a pedal board, wherein the pedal board is configured to produce and/or switch between different sounds and/or deactivate the sensors and/or switch between program modes of how the sensors function via physical buttons, rotary dials, switches and/or other sensors.

In an embodiment, the system can include proximity sensors on a surface of a guitar configured to expand its use as a percussive instrument, which can be achieved when the musician's strumming hand waves over the sensors as he or she plays, triggering external sounds in rhythm with what is being played on the guitar strings, or by tapping on the surface of the guitar where the sensors are located.

In another embodiment, the system can also include devices arranged to replace physical controls with motion sensors. For example, a button, a switch, a key, a dial, a knob, a slider, a touch pad, a joystick, or any other physical control that may be found on a controller.

In yet another embodiment, the system can include a program module. The program module allows the sensors to function in a plurality of ways, such as but not limited to as a binary button that you can either wave your hand above, or physically touch to activate, and/or as a gradual dial that you move your hand up and down to increase and decrease. The system can also include a program module which is configured to allow all sensors to do either all or some of the functions as described.

In embodiments, the system can include 3.5 mm MIDI in/out/thru ports, CV/Gate/Velocity ports, and Clock in/out ports configured to provide connection to other music hardware. These ports can be positionable on the side surfaces of system devices so as to provide these connection to other music hardware without impeding playing of the system by a user.

In embodiments, the system includes a compact, portable MIDI controller structured to fit in a person's pocket. Further, the system can also include a small MIDI controller with onboard sensors that is easily transportable and can be played on a variety of surfaces.

In embodiments, the system can also include a mini drum machine equipped with sensors as its primary means of sound triggering and manipulation.

The system can also include programming to allow system interaction with directional gestures on an x-y axis, so the sensor will register left to right motions, right to left, up to down, down to up, and any combination including diagonal. This can be done by grouping four or more sensors and/or sensor components together to function as one sensor unit. In an embodiment the program module will register lateral motions, and/or also up and down motions all together, to create a three-dimensional x-y-z axis. The system can emulate a joystick that also moves up and down, which provides both lateral and vertical control simultaneously, for example, being able to move laterally across a digital plane while at the same time being able to zoom in and out, all with the movement of your hand without physically touching a control surface.

In embodiments, a plurality of sensors and/or sensor components can be grouped together to register motions of designated fingers. Embodiments can require a combination of a proximity sensor matrix and other motion sensing technology, to register, even more complicated gestures: zig-zag, clock-wise and counter clockwise circular movements, and/or even any shape in two dimensions, such as but not limited to, a square, a circle, an oval, a rectangle, a triangle, and/or a trapezoid and/or shapes in three dimensions such as but not limited to a cube, sphere, cone, egg shape, and/or droplet. Further, the plurality of sensors can be grouped together with other motion and/or image sensing technology to specifically register common gestures, such as but not limited to snapping one's finger of clapping one's hands. Further still the system can include accelerometers and gyroscopes to register the orientation and rotation of the device itself, while also registering the 3-D movement of your hand above it.

In embodiments, the system can include a program module arranged to actuate system response with gesture sensing and/or rotational sensing. The system can also include short and/or long distance infrared proximity sensors. The system can also include sensors such as but not limited to passive infrared sensors (PIR), laser sensors, microwave sensors, dual technology motion sensors, area reflective type, ultrasound, and/or vibration sensors.

In embodiments, the present invention can include a musical device configured to utilize motion-sensing technology to digitally control audio. Further, the system can be a MIDI controller structured to be motion-sensitive by way of onboard proximity sensors arranged such that a user can interact with the system to generate and/or manipulate sounds, effects, and parameters, musical and/or non-musical, within an integrated system of digital/analog instruments, hardware, and software.

In embodiments the system can be configured to provide an expanded kind of playing experience, one that allows a musician to perform the functions of pressing keys, hitting pads, and turning dials all through a single gesture. This use of proximity sensors introduces new methods of digital audio control that are capable of producing extraordinary rhythmic effects and integrated sounds with uninterrupted precision.

In embodiments, the system can include a compact rectangular enclosure, with dimensions of about 5½″ L×1½″ W×⅜″H. The enclosure can be composed of various materials including metal and/or plastic.

In embodiments, two proximity sensors can be positionable on a top surface of the enclosure, one sensor on a left-hand side and another sensor on a right hand side of the top surface of the device and spaced away from a top display and from each other such that the proximity sensors can be controlled and/or actuated independently from one another and configured so a musician can utilize left and right hands to interact with the right and left hand top sensors without disrupting visibility of the top display.

In embodiments, the system can include a graphic display, such as an LCD display, positionable centrally on the top surface of the enclosure and occupying up to roughly ⅓ of the top surface of the device.

In embodiments, the system can include LED lights/meters/matrices, and other types of displays.

In embodiments, the system can include a rotary thumbwheel on a back side surface of the device used for general navigation. Further, thumbwheel can also act as a push button. The position of the thumbwheel on a right of center position of the backside of the enclosure allows the musician to utilize their thumb and/or thumbs to interact with the device.

In embodiments, the system can include one, two, and/or a plurality of push buttons on the side surface of the device to navigate banks, modes, and settings.

In embodiments, the system can include a switch on the side surface of the device and a plurality of additional switches or buttons for onboard navigation of settings.

In embodiments, the system can include multiple ports positioned on the side surface(s) of the device. Further, the system can include but not limited to: one or a plurality of USB ports, one or a plurality of 3.5 mm MIDI OUT ports, one or a plurality of 3.5 mm MIDI IN ports, one, two, and/or a plurality of 3.5 mm CV (control voltage) ports, one, two, and/or a plurality of 3.5 mm GATE ports, rubber (or other material) pad or feet on underside of the device to stabilize on flat surfaces (i.e. a desk), and/or one or a plurality of mounting clips and/or screw holes (on 4 corners) of device for optional application to other instruments/hardware.

In embodiments, the device can be designed to facilitate one-handed or two-handed playing, which have informed design choices, such as but not limited to maintaining the top surface of the device completely flat with only the display window and the two sensors flush with the top surface, with adequate spacing in between the sensors to allow unobstructed one-handed or two-handed playing.

In embodiments, the device can be configured to position location of ALL physical controls and communication ports (rotary thumbwheel, navigation buttons, switches, USB port, MIDI ports, CV/Gate ports) on the side surfaces of the device which further serves the purpose of leaving the top playable surface unobstructed.

In embodiments, the location of the thumbwheel, which in certain iterations will be the device's primary navigational mechanism, can be located on the back-side surface of the device which allows the user easy navigational control without getting in the way of the sensors” effective ranges. For example, when the device is laying flat on a desk, the user's right hand may hook the top-side surface of the device with its forefinger while turning the wheel with its thumb, leaving the top surface unaffected. In another example, the user's hand may hold the device in its palm while turning the wheel with its thumb, similarly leaving the top surface unaffected.

In embodiments, the device can be small enough to fit in your pocket, making it easily portable and adaptable to a variety of setups and configurations for usage and performance, including but not limited to:

In embodiments, the enclosure can rest on a table and be played with one or two hands—similar to how one would play a small drum such as a bongo—each hand interacting with a sensor, with or without physical touch.

In embodiments, the device can be picked up with one hand and struck with the other hand—similar to how one would play a maraca or a tambourine—to engage one or more of its sensors with or without physical touch.

In embodiments, the device can be mounted on or integrated into a plurality of digital and/or analog musical instruments in a plurality of physical arrangements.

In embodiments, interaction with the device's sensors can be of a rhythmic or melodic nature, or both. For example, the user's hands can hover above the sensors—similar to how one would play a theremin—to affect gradual and/or velocity-based parameters such as pitch, volume, or any musical effect. The user may also strike it percussively to trigger binary sounds—similar to how one would play a drum machine—or also swipe above it in mid-air for binary or gradual actuation. Any combination of the above is possible at once.

It's important to note that using proximity sensors for musical triggering and modulation can produce some rhythmic effects that would otherwise be technically impossible to perform on typical control mechanisms such as buttons, pads, dials or faders. While electronic music performers have become incredibly dexterous at playing these mechanisms (i.e. a DJ rhythmically sliding a fader up and down at great speed), there is still a degree of physical friction inherent in these mechanisms between the user's gesture and the sound being modulated. You can only turn a dial so fast, and it would be very difficult to do it rhythmically while simultaneously pressing a button with the same hand and with the same cadence. The present invention not only makes this possible but also makes it intuitive and easy, as a single hand gesture can do all of the above with no resistance since it is only interacting with a flat surface and the empty space above that surface.

In embodiments, each sensor can function in a number of ways, the three major categories being binary control, gradual control, and velocity control. Further, a sensor can trigger binary commands such as MIDI notes.

In embodiments, a note can be played when the sensor is physically touched (note ON) and stop playing when the user's hand releases contact with the sensor (note OFF).

In embodiments, a note can also be played when the user's hand crosses the threshold of sensor in mid-air (note ON) and stops playing when the hand escapes threshold (note OFF).

In embodiments, there can also be an alternate mode that incorporates both: a note can be played when the user's hand crosses the threshold of the sensor (note ON) and stop playing when the hand exits the threshold (note OFF). However, if the hand remains within the threshold AND the sensor is physically touched once—the note will henceforth be triggered by physically tapping the sensor any number of times until the hand exits the threshold of the sensor entirely.

All of the above can affect either a single note or any number of notes at once. Moreover, different notes can be triggered in accordance with different preset threshold values, creating an arpeggio effect (akin to sliding a finger up or down plano keys). This can all be customized in the user settings.

In embodiments, the sensor can affect gradual parameters such as MIDI CC values.

In embodiments, gradual parameters (i.e. any musical effect) change according to how close the user's hand is to the sensor. For example, a parameter starts at 0% when the threshold of the sensor is uncrossed. When the user's hand crosses the threshold, it gradually increases as the user's hand gets closer to the sensor, reaching 100% when the sensor is touched. The values then decrease as the hand moves away from the sensor, returning to 0% when the user's hand exits the threshold. Linear or logarithmic scaling of these movements are customizable in the user settings.

In embodiments, conversely, the values can be inverted so that the parameter is at 100% when the threshold of the sensor is uncrossed and at 0% when the sensor is touched. This can be customized in the user settings.

In embodiments, the threshold value(s) can also be customizable. If the user wants a shorter threshold, for example, they can reduce the distance of the effective range of the sensor in the user settings. Moreover, if the user wants multiple threshold values set at different distances to modulate different effects, that is also customizable in the user settings.

In embodiments, the sensor can include velocity-based modulation, such MIDI Note Velocity or MIDI Polyphonic Expression (MPE). Depending on how fast a predetermined range of values within the threshold of a sensor is crossed when, for example, playing a note, any number of parameters related to that note can be modulated accordingly. For example, if the threshold range of the sensor is crossed quickly, the note plays loudly, whereas if it's crossed slowly, the note plays softly. This is not just limited to volume; any other effect such as pitch, resonance, filter frequency, reverb, delay, waveform shape, distortion, and virtually any parameter value can be modulated based on the velocity of the user's hand interacting with the sensor.

In embodiments, all velocity-based sensor threshold values and ranges are customizable in the user settings.

In embodiments, the graphic display shows the main user interface, which includes basic user info and menu settings including but not limited to MIDI mappings, MIDI notes, CC numbers, MIDI channels, modes, sequencer settings, and bank numbers.

In embodiments, the default user interface may consist of a 4×4 matrix of 16 squares shown in the center of the display, with other basic information such as current MIDI mappings and current bank number displayed below it, as well as graphic meters on the left and right side of the display to visually represent user interaction with each sensor.

In embodiments, a display may show a 4×4 matrix is numbered from left-to-right, bottom-up, with the bottom left slot being #1 and the top right slot being #16. Within the 4×4 matrix, squares 1-8 correspond to sensor #1 and squares 9-16 correspond to sensor #2. By default, MIDI notes and CC values are mapped to each sensor in an 8-step grid.

For example, bank #1 would have the following MIDI mappings:

Sensor 1: Note C1-Note G1/CC 1-CC 8

Sensor 2: Note G #1-Note D #2/CC 9-CC 16

And bank #2 would shift to the next group of 16 notes/CC values:

Sensor 1: Note E2-Note B2/CC 17-CC 24

Sensor 2: Note C3-Note G3/CC 25-CC 32

All MIDI note assignments and CC values are customizable in the user settings.

In embodiments, by default, one MIDI note/CC value is active per sensor at a given time. For example, when the device is initiated, in bank #1 the note C1/CC 1 will be playable on sensor #1 and the note G #1/CC 9 will be playable on sensor #2. The user will be able to navigate through these MIDI notes/CC values for each sensor via the rotary thumbwheel on the side of the device (for example, switching to note C #1/CC 2 for sensor #1 or note A1/CC 10 for sensor #2).

The rotary thumbwheel can also act as a pushbutton allowing the user to switch between sensors to navigate their mappings respectively.

In embodiments, these mappings are visually represented by highlighted squares in the 4×4 matrix. The current MIDI note/CC value active for each sensor is also represented in text/numbers below the matrix so that the user can see what is currently selected. In this example, the user is in Bank #1 with Sensor 1 (S1) mapped to note C1/CC1 and Sensor 2 (S2) mapped to note G #1/CC9, represented by the two darkened squares in the matrix:

Blank

To the left and right of the 4×4 matrix are two meters, one for each sensor. The meter of the right corresponds to the sensor on the right-hand side of the enclosure (Sensor 1 or S1) while the meter on the left corresponds to the sensor on the left-hand side of the enclosure (Sensor 2 or S2). These graphic meters visually represent the user's interaction with each sensor, such as rising up and down in real time as the user's hand moves up and down over the sensor.

In embodiments, the USB port will be the primary means of communication between the device and a DAW (Digital Audio Workstation) and other computer software. The data transmitted through USB can include MIDI IN and MIDI OUT data. Additionally, the USB port can be configured to power the device.

In embodiments, the device also comes equipped with two separate 3.5 mm MIDI ports (one for MIDI IN and one for MIDI OUT) to connect to other MIDI-enabled devices, such as an analog synthesizer or a drum machine. Through these ports, MIDI data can be transmitted in and/or out of the device to any other MIDI-enabled device either in conjunction with or separate from the USB MIDI connection.

In embodiments, the device also comes equipped with CV/Gate ports for each sensor to communicate with modular synthesizers, Euro rack systems, drum machines, and other electronic instruments.

In embodiments, the device includes a step-sequencer function with editing, timing, and performance features that are configurable by one or more sensors. These features include but are not limited to the following:

Setting the sequencer tempo by tapping one or more sensors at the desired tempo. There may also be an “irregular tempo” tap feature, in which the user may tap rhythms outside of common time signatures and have them either play back as tapped or automatically quantized within a grid.

Setting the sequencer tempo by turning the thumbwheel or other onboard mechanisms and selecting the desired BPM (beats per minute) of the sequence, either independently or after tapping for tempo.

Selecting from a series of sequencer modes customizable in the user settings (allowing for 16-step, 32-step, 64-step, or any amount of steps within a sequence). For example, a 16-step sequence may be selected, which creates a musical sequence corresponding to the 16 mappings in each bank (i.e. MIDI notes C1-D #2). The sequence will cycle through mappings 1-16 (MIDI notes C1-D #2) at the selected tempo/BPM and repeat. If more nuanced sequences are desired, a 32-step sequence may be selected, which, for example, would cycle through mappings 1-16 of bank #1 and mappings 1-16 of bank #2 and then repeat. Higher or lower step sequences are all customizable in the user settings.

Alternately, two or more sequences can run at the same time, one corresponding to mappings 1-8 and the other corresponding to mappings 9-16, for example. If more steps or sequences are desired, this is also customizable in the user settings.

In another mode, one sequence may be set at one tempo and/or time signature by tapping one sensor and another sequence may be set over it by tapping a different tempo and/or time signature on another sensor.

As any sequence is running, any effect or parameter can be mapped to each sensor to modulate the sequence in real time in a variety of ways, including but not limited to event duration, glide effects, filter cutoff, resonance, saturation settings, waveform morphing, panning, pitch-shifting, and swing settings. Furthermore, the sequence can run or play either independently of sensor interaction or, for example, can run or play only when the threshold of one or more sensors is crossed.

As any sequence is running, any effect or parameter can be mapped to each sensor to modulate the sequence in real time in a variety of ways.

Velocity-based modulation can also be mapped to each sensor while the sequence is running to modulate parameters related to the sequence or the individual sequence steps as they play. In embodiments the system can include capabilities configured for a musician to use the device as a two-handed percussive musical instrument. Further, the device may be structured to be utilized as a MIDI drum machine. Additionally proximity sensors, side ports, a thumbwheel, and display are positionable on an enclosure to allow the musician to interact with the top sensors with left and right hands, wherein the sensors are located on opposite ends of the top of the enclosure and sufficiently distanced away from the display to allow the musician to play the musical instrument while not obstructing the view of the display, and wherein the thumbwheel is located on a backside of the enclosure positioned to be operated with the musician's thumb.

In embodiments, the system can be arranged to include musical data such as MIDI notes, CC values, bank numbers, presets, velocity curves, velocity values, MPE values, MIDI channels, CV/Gate channels, sequence data, BPM, clock data, presets, minimum values, maximum values, and a real time visual representation of sensor interaction and sensor readings

In embodiments, the device can be configured as a musical instrument, in many capacities a percussive one, so the enclosure, particularly the top surface, will need to withstand physical contact, in spite of the fact that direct contact with the sensors is not necessary to play the device. While the proximity sensors can be actuated without physical contact, they can also be actuated by being physically touched/struck, so the control surface needs to be sturdy and resilient to accommodate both playing styles.

In embodiments, the system can be designed to be played with a human hand, other iterations may include a device that features a softer material with high tensile strength and better rebound elasticity such as gum rubber either around the sensor units, covering most of the control surface, or covering most of the enclosure so as to allow the user to interact with the sensors and strike the device with not just their hands but also blunt objects such as a drumstick.

In embodiments, this device may act as a hub for other auxiliary Proxy® devices within the same family, which may or may not contain additional sensors, and which can connect to this hub either through side ports or through wireless (i.e. bluetooth) connection, all within an integrated system. These auxiliary devices may include a pedal board for additional navigational control. They may also include smaller, thinner devices (i.e. rectangular enclosure of 1½″×1″× 3/16″) with individual sensor units that can be attached/incorporated/clipped to other musical instruments, either acoustic, electric, analog, or digital.

In embodiments, additional SIDE sensors may be incorporated. For example, on the top right and top left corners of the device, side sensors can be placed so that the sensor beam points horizontally away from the sides/corners of the enclosure, allowing the user to tap not just the device itself but the area around the device, such as tapping the surface that the device is resting on (i.e. a desk) and actuating the side sensors that way to, for example, play an additional MIDI note by physically tapping the desk itself in proximity to the device. Further, the system can provide for an additional way in which the placement of the sensors as well as the direction and angle of their beams in relation to the device enclosures can be used for musical/percussive purposes.

In embodiments, each sensor may be covered with a protective lens. For infrared proximity sensors, an IR pass filter lens (allowing a range of, say, 800 nm-1064 nm) may be used so as to allow only the sensor's IR beam to pass through it. Other materials for protective lenses may include acrylic plexiglass, polycarbonate, poly(methyl methacrylate), glass, and other translucent material.

In embodiments, the system can include RGB color sensors, the color sensors configured to return an amount of red, blue, green, and/or clear light based on the system actuation and programmed response. The system can be arranged to play different notes on a scale based on the color of the object being waved in front of the sensor, and/or a light that changes colors to morph into different notes. The system can also include heat and/or temperature and/or humidity sensors and/or pressure sensors. For example, the pressure sensors programmed response can be tuned to measure how hard a sensor is being pressed. This functionality can be programmed into a MIDI controller providing key sensitivity. The system can include system responses which emulate, such as, playing a plano key softly, as opposed to hitting it hard and getting a louder sound. Furthermore, key sensitivity can also be measured by proximity sensors without the need for physical touch such as but not limited to measuring the velocity by which a hand moves past a sensor—faster velocities generating louder sounds and slower velocities generating softer sounds.

In embodiments, the system can include wind speed sensors, air quality sensors, barometric pressure, altitude sensors, waterproof liquid sensors, piezoelectric sensors, electrochemical sensors, image sensors, current sensors and/or voltage sensors.

In an aspect, the system can include light sensors.

In another aspect, the system can also include the capability of transmitting digital signals, the signals designed to be read by a plurality of computer programs.

In yet another aspect, the system can include program modules configured to produce different sounds from the same sensor. The different sounds resulting from interaction with a motion sensing mechanism detecting a plurality of movements and/or a plurality of velocities of movement over and/or in the proximity of the sensor.

In an embodiment, the system can include a program module designed to filter out motions and/or movements and/or velocities of movements in order to minimize system response to avoid erratic and/or extraneous sounds and/or noise.

In another embodiment, the system can also be actuated by moving a dial or by waving over the sensor to emulate turning a dial.

In yet another embodiment, the system can be actuated by three-dimensional motion.

In an aspect, the system can be actuated and/or operated without any physical contact with the system.

In another aspect, the system can also be actuated by both movement and physical touch with the system.

In yet another aspect, the system can interact with a plurality of digital audio workstations (DAW).

In an embodiment of the present invention, the system can be operated and/or activated without any physical contact with the system. The system can include a control surface wherein the control surface works without the use of physical touch. The system can also be arranged for a user to physically touch the control surface if he or she wants, as an option. The system can have the capability of doing both.

In another embodiment of the present invention, the system can also include a controller that uses sensors in the place of physical controls to affect parameters in a variety of software/hardware.

In yet another embodiment of the present invention, the system can include a MIDI controller that uses sensors in the place of physical controls to affect parameters in digital audio software/hardware.

In an aspect, the system can include a system and/or method which makes use of the negative space directly above and around the surface of the system itself, converting what would otherwise be considered empty air into a new kind of kinetic experience based on a musician's movements around the system.

In another aspect, the system can also include an apparatus which is itself the controller.

In yet another aspect, a method of creating sound with an integrated musical instrument system can include actuating the integrated musical instrument system with motion to trigger and/or manipulate sounds and effects by using a variety of physical gestures, such as but not limited to moving a hand up and down to gradually increase and/or decrease a sonic parameter. In embodiments, the system can also include simulations. These simulations can include holographic projections above the control surface that simulate the sensation of physical friction when, for example, a musician's hand interacts percussively with the edges of a holographic shape to simulate high or low levels of friction, resistance or bounce, which can be customized to simulate the feel or touch of a variety of musical instruments and/or physical mechanisms in a customizable way. Aside from auditory feedback, these holographic simulations can provide visual and tactile feedback when interacting with devices.

In embodiments, the system can include hologram projections above the control surface and/or around the sensors that simulate the selected functionality of each sensor, such as a cube-shaped hologram that can be virtually pushed down, or a cylinder-shaped hologram that can be virtually turned like a dial, without physical contact with the control surface. The system can also provide for holograms that shape-shift depending on what functionality the sensor is taking, or that combine shapes when the sensor features multiple functions at once. The system can include a visual representation of the sensors' actuation and detection in the form of holographic images.

These and other objects, features, and advantages of the present invention will become more apparent from the attached drawings and the detailed description of the preferred embodiments, which follow. It is understood, that the drawings are designed for the purposes of illustration and not as a definition of the limits of the embodiments of the present invention. It should be further understood that the drawings are not necessarily drawn to scale and are merely intended to conceptually illustrate the methods and systems described herein.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a front view of a portion of an integrated musical instrument system on a guitar, in accordance with an embodiment of the present invention;

FIG. 2 presents a perspective view of a pedal board;

FIG. 3 presents a perspective view of a portable integrated musical instrument system;

FIG. 4 presents a top front perspective view of an embodiment of the present invention;

FIG. 5 presents a top back perspective view of an embodiment of the present invention;

and

FIG. 6 presents a bottom back perspective view of an embodiment of the present invention.

Like reference numerals refer to like parts throughout the several views of the drawings.

### DETAILED DESCRIPTION

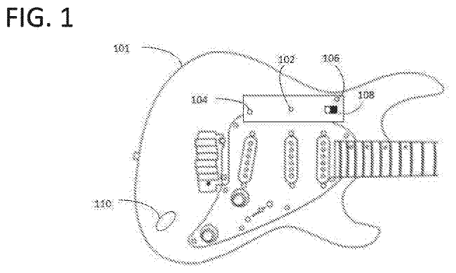

The following detailed description is exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, embodiments of the present invention are directed towards methods and systems for integrating musical instruments and/or software with devices and sensors. These devices and sensors can function in concert and configured as an integrated musical instrument system.

Referring initially to FIG. 1, an integrated musical instrument system is illustrated with an embodiment of the present invention. As seen in FIG. 1, an integrated musical instrument system can include a guitar 101. The guitar 101 can include proximity sensor 102. The proximity sensor 102 can function as a binary (on/off) sensor, with a plurality of responses and/or parameters upon activation. For example, with 3 parameters, such as downward, when a hand crosses the threshold of the sensor, held downward when the hand stays within the threshold of the sensor 102, and upward when the hand exits the threshold of the sensor. When a hand crosses the sensor's 102 threshold, a sound mapped on a Digital Audio Workstation (DAW) can be configured to activate. The DAW can be include a launch mode. The launch mode can be programmed within the DAW, to respond with a plurality of responses. For example, play and continue playing if the hand remains within the threshold and/or stop playing when the hand exits the threshold. The threshold distance of the sensor 102 may be set to about 100 mm away from the sensor 102, and may be configured to be coded to have a shorter or longer threshold, for example, with a maximum of about 200 mm. Different sensors may include different threshold ranges, such as but not limited to, about 10 mm to 500 mm. For example, the guitar 101 threshold may be on the lower range of thresholds so that unwanted objects/movements don't interfere with playing the guitar 101 and the musician can have a more microscopic control of what is being triggered.

Continuing with FIG. 1, proximity sensors 104 and 106 can be included in an embodiment. The sensors 104 and 106 can be configured to function similarly to proximity sensor 102, and can be configured to be coded to transmit gradual increments. For example, such as but not limited to, between the values of 0 to 127, 0 being off and 127 being turned up 100%. In embodiments, the system can include values of 60 to 187. Also, in embodiments, the system can include negative values. The sensors 104 and 106 can include a plurality of MIDI-mapped effects configured to the sensors 102, 104 and/or 106. For example, the proximity sensor 102 may trigger a sound, the sensors 104 and 106 can be configured to add an effect, gradually, and in real-time when the threshold of the proximity sensors 104 and 106 are activated. For example, a vocal sample can be triggered with sensor 102 and an echo effect can be added and can be configured with sensors 104 and/or 106, a value of 0 being no echo, a value of 127 corresponding to maximum echo in the DAW. The threshold ranges on the sensors 104 and/or 106 may be set at around the same as proximity sensor 102.

As best seen in FIG. 1, gradual sensors 104 and 106 can be configured to operate similarly to proximity sensor 102. Further, sensor 104 can be configured to operate similarly to sensor 106. A switch 108 can be arranged such that the gradual sensors 104 and 106 can be configured to switch and/or alternate between the sensors 104 and/or 106. In an embodiment, sensors can be configured to switch to the right, for example, the upper right sensor 106 can be active and the left sensor 104 may be inactive. In an embodiment, sensors 104 and 106 can be configured to switch to the left, for example, the lower sensor 104 can be active and the right sensor 106 can be inactive. In embodiments, a musician can have two options in terms of where to configure the gradual sensors 104 and/or 106, either further away from a musician's hand or closer to the hand. The sensor 102 may be configured to always be active and may not be affected by the switch 108.

In an embodiment, the sensors 102, 104, and/or 106 may be configured to be active, and the sensors 102, 104, and/or 106 can be configured in any variation of the on/off and/or gradual functionality.

In an embodiment, sensors 102, 104, and/or 106 may be active and/or configured in a plurality of alignments of binary, on/off, and/or gradual functionality.

In an embodiment, an integrated musical instrument system can include a plurality of sensors, including but not limited to, 5, 10, 20, 30, 50, and/or 100 sensors.

In embodiments, an integrated musical instrument system may include shielding, the shielding configured to prevent the sensors, which are close to the instrument pick-ups, from producing unwanted interference/noise.

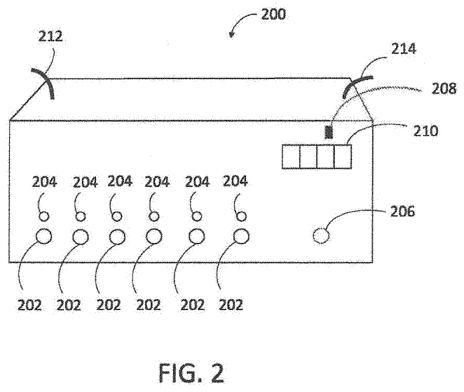

As shown in FIG. 1, a XLR cable connection 110 can be configured to connect with an XLR cable, not shown. The XLR cable can be configured to connect the sensors 102, 104, 106 and/or the switch 108, and/or a sensor plate, and/or connections to lights and/or other components on the musical instrument, to an external pedal board 200, as seen in FIG. 2.

Referencing FIG. 2, the pedal board 200 can include buttons 202 configured to activate the sensors 102, 104, and 106 on the guitar 101, as shown in FIG. 1. The buttons 202, when not actuated, may configure the sensors 102, 104, and 106 inactive. The buttons 202, may be configured individually and/or in combination corresponding to preset mapping to the sensors 102, 104, and/or 106 to a plurality of sounds and/or effects in the DAW. The DAW may be pre-programmed and musical instrument digital interface (MIDI)-mapped in advance. The buttons 202, individually and/or in combination, for example, when actuated may configure the sensors 102, 104, and/or 106 active. The lights 204 can be light emitting diodes (LED). The lights 204 may energize when a corresponding button 202 below the light 204 is actuated. The sounds and effects in the DAW can include, but not limited to, drum sounds, tones of varying frequencies and timbre, pre-recorded samples, synthetic sound waves, reverberation, distortion, delay, chorus, vibrato, volume, pitch-shifting, time-warping, equalization, compression, panning, and/or a plurality of sounds and/or effects. The sensors 102, 104, and/or 106 can be configured to trigger sounds and/or effects when an object comes within proximity to sensors 102, 104, and/or 106. The buttons 202 can trigger a corresponding light 204 to de-energize when the buttons 202 are actuated, iteratively. Buttons 202 can be configured with individual preset sounds and/or effects.

Continuing with FIG. 2, the pedal board can include a bank up switch 206 and bank down switch 208. The bank up switch 206 and the bank down switch 208 can be configured to provide a new set of sounds and/or effects corresponding to the buttons 202. The bank up switch 206 and bank down switch 208 can include a plurality of bank levels. The plurality of bank levels can be arranged to provide different sounds and/or effects for the buttons corresponding to the bank levels. A numeric display 210 can be configured to display corresponding active buttons 202 and/or bank level. A XLR cable 212 may connect the pedal board 200 to the guitar 101, as seen in FIG. 1. A universal serial bus (USB) cable 214 can be arranged to connect the pedal board 200 to a computer, not shown. In embodiments, the pedal board 200 and/or the sensors 102, 104, and/or 106 may be configured to be energized through the USB cable 214. The buttons 202 individually and/or in combination may be configured to be proximity sensors.

In embodiments, the pedal board 200, the buttons 202, the lights 204, and/or the sensors 102, 104, and/or 106 can be configured to operate independently from strings, pick-ups, and/or the guitar 101. In embodiments, the sounds and/or effects produced from the pedal board 200, the buttons 202, and/or the bank up switch 206 and/or bank down switch 208 can be configured to be produced in parallel to sounds and/or effects generated from the guitar 101.

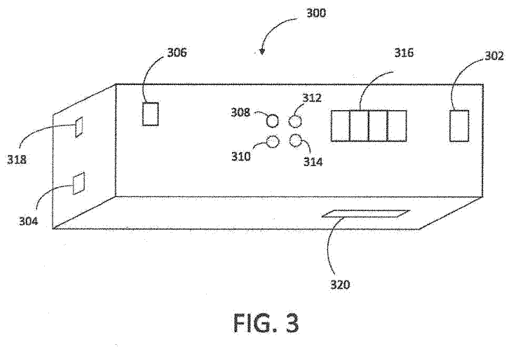

As best seen in FIG. 3, an embodiment of the present invention can include a portable integrated musical instrument system 300. The system can include a trigger sensor 302. The system can also include a gradual effect sensor 304. The system can include a sound up sensor 306. The system can also include sound up sensor or button 308 and sound down sensor or button 310. The system can include bank up sensor or button 312 and bank down sensor or button 314. The system can also include a numeric display 316. The numeric display 316 can be configured to display sound and/or bank level. The system can include input/output connection 318 and input/output connection 320.

In embodiments, the system 300 can include a USB port. The USB port can connect to a computer, not shown. The USB port can also provide power to the system 300. The system can also include a stand-by switch configured to deactivate the sensors. The system can additionally include a switch on a side of the system 300 which can deactivate the sound up sensor 306.

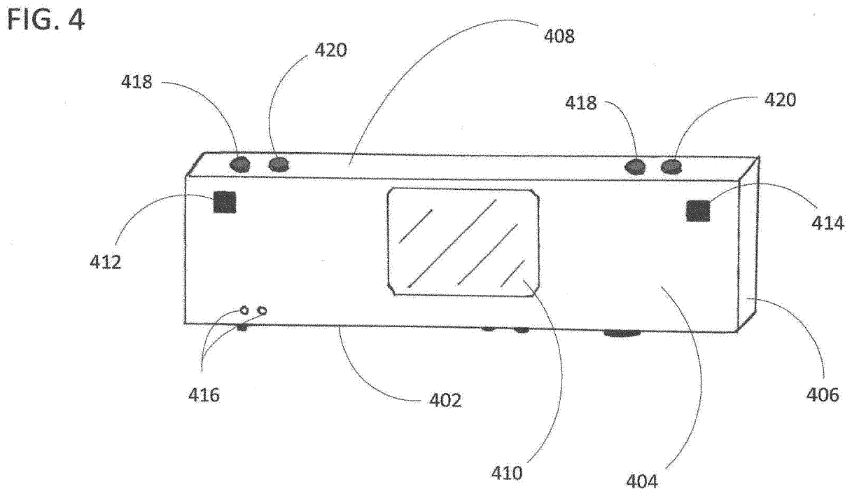

Turning to FIG. 4, an embodiment of the present invention can include a musical instrument system 400 housed in a compact rectangular shaped box like enclosure 402 which can utilize motion sensing technology to digitally control audio. The enclosure 402 can include a flat topside surface 404, a right-hand side surface 406, and a front side surface 408. A graphic display 410 can be positionable centrally on the topside surface 404 and occupy about ⅛ to about ⅓ of the topside surface 404. A left-hand side proximity sensor 412 positionable on an upper top and towards a left-hand side edge of an area of the topside surface 404. A right-hand side proximity sensor 414 positionable on an upper top and towards a right-hand side edge of an area of the topside surface 404. Both right hand side proximity sensor 414 and left-hand side proximity sensor 412 are configured on the topside surface 404 to allow a musician to interact with the sensors, 412 and 414, with a musician's left and/or right hands without impeding the musician's view of the graphic display 410 while playing the musical instrument system 400.

Continuing with FIG. 4, light and displays 416 may be positionable on a lower left-hand side of the topside surface 402. Further, control voltage (CV) ports 418 can be positionable on left- and right-hand sides of the front surface 408. The system 400 can also include GATE ports 420 positionable on left- and right-hand sides of the front surface 408. Positioning of the sensors and system 400 components allow the musician to play the musical instrument 400 and to not allow the placement of the logistical components of the system 400 to interfere with the musician's access to sensors, 412 and 414, and other controls and to prevent obstruction of the musician's view of the graphic display 410. In embodiments, the CV and GATE ports 418 and 420 can include 3.5 mm ports.

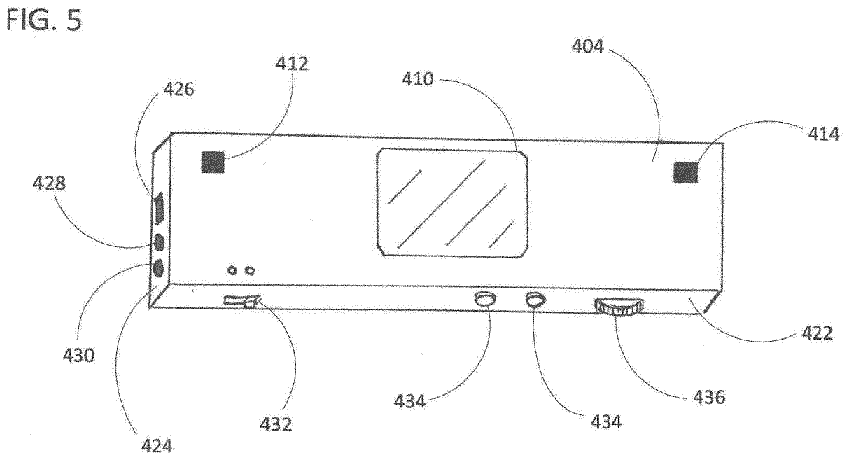

As best seen in FIG. 5, the musical instrument system 400 can also include interconnection points and other system controls on a back side surface 422 and a left-hand side surface 424 of the enclosure 402. A USB port 426 can be located on a left-hand side surface 424 of the enclosure 402. Also, a MIDI output port 428 and a MIDI input port 430 can be located on a left-hand side surface 424 of the enclosure. In embodiments, the MIDI ports, 428 and 430 can include 3.5 mm ports.

Various controls can be located on the back side surface 422 of the enclosure 402 and designed to be controlled by the musician's right- and left-hand thumbs. A switch 432 or a plurality of switches 432 or buttons 432 can be located on a left-hand side of the back side surface 422 of the enclosure. The system 400 can include 2 push buttons 434 to navigate banks located on a back side surface 422 of the enclosure 402. On a right-hand side of the back side surface 424 of the enclosure, a rotary thumbwheel 436 can be positioned. In embodiments, the rotary thumbwheel 436 can also include push button controls.

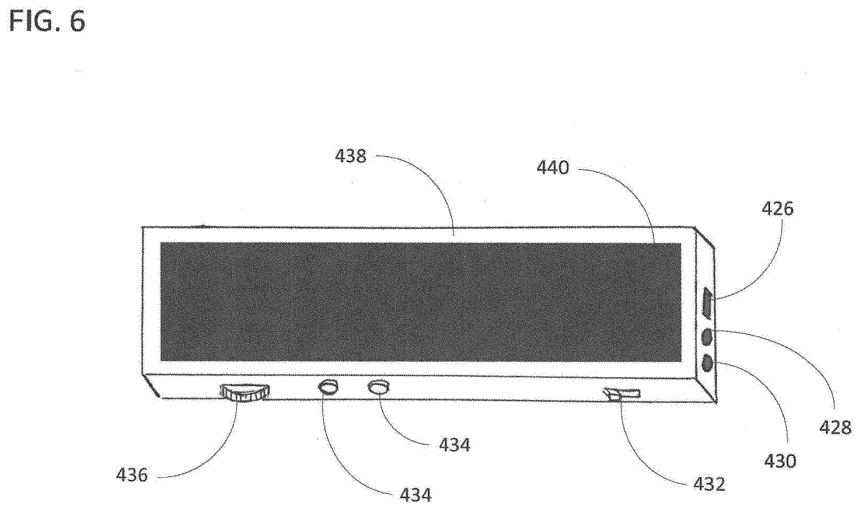

FIG. 6 shows a bottom side 438 of the enclosure 402. Positionable centrally on the bottom side 438 can be a damping pad 440. The dampening pad 440 can be configured to allow the enclosure 402 to rest upon a flat surface while the musician plays the musical instrument 400.

In embodiments, the system can include trigger sensors 1 and 2 on the face of the box and can function in the same way a simple binary button or a key would. When your hand crosses the threshold of the sensor's field of detection, for example about 1, 2, 3, 5, 10, 20 cm above the sensor or any dimension in between, it's the same as if you were to push down on a button and holding down if your hand remains in the field of detection. As soon as your hand leaves the threshold, it's the same as if you were releasing the button. The system can also be programmed so that you can also touch the sensor to achieve the same functionality. The system feature helps for musical purposes because sometimes you want to tap a button repeatedly, very quickly, which is easier to do by actually tapping the surface of the box, as opposed to waving your hand above it, which you can also do. The system can include a plurality of ways to actuate the system. The system can also include two ways of pushing this imaginary button, by waving your hand in the air above the sensor, and by physically tapping the sensor.

In embodiments, the “effect” sensor on the side of the box functions like a knob or a dial would. When unaffected, the knob is at 0%, as soon as your hand crosses the threshold of detection and moves closer and closer to the sensor, it gradually goes up to 100% and remains at 100% if your hand is touching the sensor. This can manipulate effects that a musician may want to turn up or down in real time, such as volume, panning, distortion, reverb, delay, or any effect in a DAW or other software/hardware. Interaction with a DAW allows you to customize the range of each sensor, for example, from 0% to 50% In addition, the range of each sensor can be adjusted in the program module, depending upon user settings.

In embodiments, the “effect” sensor on the side of the box functions like a knob or a dial would. When unaffected, the knob is at 0%, as soon as your hand crosses the threshold of detection and moves closer and closer to the sensor, it gradually goes up to 100% and remains at 100% if your hand is touching the sensor. This is useful for sound effects that you want to turn up and down volume, panning, distortion, reverb, delay, etc. basically any effect imaginable that is supported by your DAW. Any gradual effect or parameter is customizable in your DAW. If you only want a certain effect to go up to a maximum value of 50%, you can set that as your max value in your DAW, so when the sensor is at its maximum value of 100% the parameter will only go up to 50%. Interaction with DAW allows you to customize the range of each sensor. In addition, the range of each sensor can be tweaked in the program module, depending upon how it is coded.

In embodiments, the sensors in the system can include an array of sensors. The system can include algorithms and programming to program all three sensors to function both as a binary button and a gradual dial, to further customize the user experience. In the system, crossing the threshold of detection can register as “on” but also as gradually going from 0% to 100%. Furthermore, both a sound and an effect can be MIDI-mapped to the same sensor: once the threshold is crossed, the sound will play and the effect will increase 0% to 100%. In some embodiments, the sensors can include a plurality of functions.

In embodiments, the sensors on the system can include an array of sensors. There are a lot of possibilities. The system can include algorithms and programming to program all three sensors to function both as a binary button and a gradual dial, to further customize the user experience. In the system, crossing the threshold of detection can register as “on” but also as gradually going from 0% to 100%. So if you want to MIDI map just a sound to it, that's fine, it'll just be registered as “on” or “off” to play the sound, but if you want to MIDI map an effect to it, that's good too, it'll turn up the dial on the effect, nothing can trip anything up, it's how you configure things in your DAW that can determine how the sensor reacts, because it's essentially reacting in both ways at the same time). Furthermore, if you want to MIDI map both a sound and an effect to the same sensor, you can do that too: once the threshold is crossed, the sound will play and the effect will start ticking up from 0% to 100%. In some embodiments, the sensors can include a plurality of functions. The two trigger sensors can act only as buttons, and the one effects sensor can act only as a dial, and therefore all sensors may be able to act as both buttons and dials.

In an embodiment, the switch at the front of the box can include a red light and it can be a standby switch, which can be programmed such that once you turn it on, all the sensors are deactivated. This is actually very useful if you want to move the box around without having your sounds playing all over the place. The system can include a plurality of functions incorporating motion sensing technology. There are so many options that the user needs options to deactivate them as needed.

In an embodiment, the switch on the front of the box can act as a standby switch, which can be programmed to deactivate the sensors if desired. Standby mode can be indicated by an adjacent LED light.

In embodiments, the device also features a sequencer mode, which you can engage with the toggle switch on the side of the box; if you want to start a sequence, you push down on the sensor until the numbers flash, then you tap the tempo you want by tapping the sensor again at the desired tempo. The sequence will start playing at the tempo you tapped. Then you can hold down the respective sensors to play the sounds and effects mapped to them in sequence.

In an embodiment, the +/−“select” and “bank” buttons in the middle which can correspond to white and yellow numbers in a number display let you cycle through 8 selections of MIDI mappings, and 5 banks (up to 40 MIDI mappings). For example, in selection #1, a user can MIDI map a cymbal sound to sensor 1, a vocal sample to sensor 2, and a reverb effect to sensor 3. While in selection #1, those sounds/effects will play from their respective sensors. In selection #2, the user can map 3 additional sounds/effects to the sensors, and so on. This is the same as an embodiment of the present invention which includes a pedal board. The pedal board works in concert with a guitar version of the product. The user can cycle through selections with their foot, on physical stomp-box-style switches, which can theoretically also be sensors. The buttons on the prototype can also be sensors and/or physical buttons.

In an embodiment, the +/−“select” and “bank” buttons in the middle which can correspond to white and yellow numbers in a number display let you cycle through 8 selections of MIDI mappings, and 5 banks (so 40 selections, basically). What a selection means is: let's say in selection #1 you MIDI map a cymbal sound to sensor 1, a vocal sample to sensor 2, and a reverb effect to sensor 3. As long as you're in selection #1, those sounds/effects will play from their respective sensors. Once you go to selection #2, you can map 3 more new sounds/effects to the sensors, and so on. This is the same thing that an embodiment of the present invention which includes a pedal board. The pedal board works in concert with a guitar version of the product. You can cycle through your selections with your foot, on physical stomp box style switches, though theoretically they can also be sensors. The buttons on the prototype can also be sensors and/or physical buttons.

In an embodiment, a trigger sensor can have a double function, which you can use the switch on the side to engage. It's called a sequencer and it basically cycles through your 8 selections at a steady rhythm. So how it works is, you switch to sequencer mode with the toggle switch; if you want to start a sequence, you push down on the sensor until the numbers flash, then you tap the tempo you want (tapping for tempo is a very common action in the modern music world, the cool thing about mine is that you can use the sensor to do it (another functionality that embodiments of the present invention include), and the sequence will start playing at the tempo you tapped. Then you can hold down the respective sensors to play the sounds and effects mapped to them in sequence.

In embodiments, the system can be portable and handheld so that it's convenient and easy to handle and you can also pick it up and hit the sensors, like you would a maraca, which is something that makes embodiments of the invention unique, most MIDI controllers are not this small, and they cannot be picked up and played. By holding it, you have the freedom of triggering multiple sounds by interacting with multiple on-board sensors in a rhythmic fashion. Embodiments of the present invention can include a digital percussive instrument that produces different sounds depending on where you hit it.

In embodiments, the system can include materials such as but not limited to stainless steel, other metals, ceramic, plastic, composites, and/or wood. It's also very strong and can be made of stainless steel or other durable materials.

In embodiments, the system can include materials such as but not limited to stainless steel, other metals, ceramic, plastic, composites, and/or wood. It's also very strong, it can be made of stainless steel and can take a beating, you can get physical with it, you can pick it up, play it, and because the sensors are so reactive it's almost like you're playing an old percussive instrument—most MIDI controllers aren't built for that sort of thing.

In embodiments, the system 300 can include a three-way switch. The three-way switch can be configured to reorganize the sensors in a plurality of arrangements.

In embodiments, data transmitted by at least one sensor can gradually change as a distance between an object (i.e. a human hand) and the at least one sensor changes, wherein the data gets concurrently processed in real-time through a data processor, including but not limited to a microcontroller, within the system and is simultaneously converted into a series of customizable commands to play and manipulate sounds, effects and/or parameters in accordance with the object placement and the object motion and the object velocity. These commands can include binary commands, such as MIDI note on or MIDI note off messages, gradual commands, such as MIDI CC or Continuous Control/Control Change messages, velocity-based commands, such as MIDI Velocity messages, or any combination of the aforementioned commands.

In some embodiments, the method or methods described above may be executed or carried out by a computing system including a tangible computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication sub system may include wired and/or wireless communication devices to facilitate networked communication. The described methods or processes may be executed, provided, or implemented for a user or one or more computing devices via a computer-program product such as via an application programming interface (API)

While the foregoing written description of the exemplary embodiments enables one of ordinary skill to make and use what is considered presently to be the best mode thereof, those of ordinary skill will understand and appreciate the existence of variations, combinations, and equivalents of the specific embodiment, method, and examples herein. The exemplary embodiments should therefore not be limited by the above-described embodiment, method and examples, but all embodiments and methods within the scope and spirit of the exemplary embodiments as claimed.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

Insofar as the description above and the accompanying drawings disclose any additional subject matter that is not within the scope of the claims below, the inventions are not dedicated to the public and the right to file one or more applications to claim such additional inventions is reserved.

What is claimed is:

1. A system suitable for use as a musical instrument system, the system comprising:
at least one sensor;
at least one control surface configured to interface with the at least one sensor;
at least one controller configured to interface with the at least one sensor;
at least one program module configured to interface with the at least one sensor;
a base, wherein the at least one sensor and the at least one control surface are positionable on the base; and
at least one data processor configured to interface with the at least one sensor, the at least one control surface, and the at least one program module arranged to function as a musical instrument system, and wherein the at least one sensor is configured to transmit data in a binary and gradual fashion simultaneously when triggered by an object placement, object motion, and object velocity, wherein the data transmitted by the at least one sensor gradually changes as a distance between the object and the at least one sensor changes while the data gets concurrently processed to play and manipulate sounds, effects and/or parameters in accordance with the object placement and the object motion and the object velocity; and
wherein the system includes a portable device configured for controller functionality;
wherein the portable device is housed by an enclosure;
wherein dimensions of the enclosure are about 5½ inches long by about 1½ inches wide by about ⅜ inches of height;
a top display positioned centrally on a top surface of the enclosure, wherein a surface area of the display occupies from about ⅛ to about ⅓ of a total surface area of the top surface;
a USB port positioned on a side of the enclosure configured to connect to a computer;
two proximity sensors positionable on a top surface of the enclosure, wherein one sensor is located on a left-hand side and another sensor on a right hand side of the top surface of the enclosure and spaced away from a top display and from each other and arranged such that the proximity sensors can be controlled and/or actuated independently from one another and configured so a musician can utilize left and right hands to interact with the left and right hand top sensors without disrupting visibility of the top display;
two push buttons to navigate banks positioned on a back side surface of the enclosure and designed to be operated by the musician's thumb; and
a rotary thumbwheel positioned on the back side surface of the enclosure and structured to be operated by the musician's thumb.

2. The system as recited in claim 1, wherein the at least one controller further comprises a remote controller, the remote controller structured to utilize motion sensing technology.

3. The system as recited in claim 1, wherein the at least one controller further comprises a musical instrument digital interface (MIDI) controller, the MIDI controller structured to utilize motion sensing technology.

4. The system as recited in claim 1, wherein the system further comprises at least one computer system configured to process digital signals.

5. The system as recited in claim 1, wherein the sensors, include short and/or long-range proximity sensors, optical proximity sensors, infrared proximity sensors, and/or proximity sensors with a plurality of emitters, receivers, IR LEDs, and photodiodes configured for 2D and/or 3D gesture recognition.

6. The system as recited in claim 1, wherein the system further comprises at least one mobile device configured to digitally communicate with system components.

7. The system as recited in claim 1, wherein the system further comprises at least one 3.5 mm MIDI port.

8. The system as recited in claim 1, wherein the system further comprises at least one 3.5 mm Control Voltage (CV) port and at least one 3.5 mm Gate port.

9. The system as recited in claim 1, wherein the system further comprises at least one digital audio workstation (DAW).

10. The system as recited in claim 1, wherein the system further comprises at least one musical instrument digital interface (MIDI)-enabled device.

11. The system as recited in claim 1, further comprising a remote controller configured to communicate with a computer, a mobile device, a MIDI-enabled device, and/or other remote controllers within the system with wired connections or wireless technology.

12. The system as recited in claim 1, further comprising at least one switch designed for navigation of modes and settings.

13. The system as recited in claim 1, wherein the system is incorporated onto a body of a guitar.

14. The system as recited in claim 1, wherein user functions and settings are configured by mechanisms on the enclosure and/or computer software.

15. The system as recited in claim 1, wherein the system includes a sequencer, the sequencer designed to function with editing, timing, and performance features configurable by one or more sensors.

16. The system as recited in claim 1, wherein the system is configured to be incorporated onto acoustic, electric, analog, and/or digital musical instruments and/or hardware.

17. The system as recited in claim 1, wherein the sensors include configurations to allow a musician to control gradual parameters, wherein the parameters include pitch, volume, and musical effects wherein the sensors are also structured to allow the musician to strike the sensors percussively to trigger binary sounds, and wherein the musician can swipe above the sensors in mid-air to produce binary or gradual actuation.

18. The system as recited in claim 1, wherein the sensors are configurable to provide binary control, gradual control, and/or velocity control.

19. The system as recited in claim 1, further comprising digital signal transmission mechanisms, wherein the mechanisms are designed to produce signals arranged to be read by a plurality of computer programs.

20. The system as recited in claim 1, further comprising a remote controller, such as a MIDI controller, that uses proximity sensors in the place of buttons, keys, drum pads, dials, sliders, and switches as a means of control in order to transmit MIDI data in real time to any software in a computer system that accepts MIDI data making the device playable via the motions of the human body or objects interacting with the sensors.
